(19) United States
(12) Patent Application Publication
(10) Pub. No.: US 2010/0028619 A1
(43) Pub. Date: Feb. 4, 2010

(54) CARD WITH A TEARABLE SECURITY LAMINATE

(75) Inventors: John H. Ko, Woodbury, MN (US); Kanta Kumar, Maplewood, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/530,524

(22) Filed: Sep. 11, 2006

(51) Int. Cl. B32B 3/00; B32B 7/12; B32B 17/00; B32B 38/10; B32B 5/00; B32B 38/04

(52) U.S. Cl. 428/189; 428/354; 428/325; 428/349; 428/339; 156/250

(57) ABSTRACT

Tearable security laminates. More specifically, the present invention relates to a security card, comprising: a plastic card having edges; and a tearable security laminate attached to the plastic card by an adhesive layer, where the security laminate is tearable along an edge of the plastic card. In addition, the invention relates to methods of making security cards.

### TECHNICAL FIELD

The present invention relates to tearable security laminates. More specifically, the present invention relates to a security card, comprising: a plastic card having edges; and a tearable security laminate attached to the plastic card by an adhesive layer, where the security laminate is tearable along an edge of the plastic card. In addition, the invention relates to methods of making security cards with security laminates.

### BACKGROUND OF THE INVENTION

A number of security features have been developed to help authenticate a document of value, thus assisting in preventing counterfeiters from altering, duplicating or simulating a document of value. Some of these security features may include overt security features or covert security features. Overt security features are features that are easily viewable to the unaided eye, such features may include holograms and other diffractive optically variable images, embossed images, and color-shifting films. In contrast, covert security features include images only visible under certain conditions, such as inspection under light of a certain wavelength, polarized light, or retroreflected light. One example of a security laminate that includes both overt and covert security features is 3M™ Confirm™ Security Laminate, which is commercially available from 3M Company based in St. Paul, Minn. This security laminate may be used with documents of value, such as identification cards, badges and driver licenses, and assists in providing identification, authentication and to help protect against counterfeiting, alteration, duplication, and simulation. Other examples of security laminates that include both overt and covert security features are illustrated in U.S. Pat. Publication No. 2003/0170425 A1 “Security Laminate,” (Mann et al.), and U.S. Pat. Publication No. 2006/0029753-A1, “Tamper-Indicating Printable Sheet for Securing Documents of Value and Methods of Making the Same,” (Kuo et al.) Examples of some other security-related devices or films are taught in U.S. Pat. Nos. 3,801,183, 4,688,894, and 6,288,842.

### SUMMARY OF THE INVENTION

Embodiments of the invention are generally directed at tearable security laminates and in particular, security cards with tearable security laminates attached to them. In one embodiment, the invention is directed to a security card comprising: a plastic card having edges; and a tearable security laminate comprising: a retroreflective layer comprising a plurality of microbeads partially embedded in a beadbond layer; a reflector layer between at least one of the microbeads and the beadbond layer; and an adhesive layer attached to the beadbond layer; where the security laminate is attached to the plastic card by the adhesive layer, and where the security laminate is tearable along an edge of the plastic card to form a tear in the security laminate that aligns with the edge of the plastic card.

In another embodiment, the invention is directed to a method of making a security card with a security laminate, the method comprising the steps of: providing a plastic card having edges; providing a tearable security laminate comprising: a retroreflective layer comprising a plurality of microbeads partially embedded in a beadbond layer; a reflector layer between at least one of the microbeads and the beadbond layer; and an adhesive layer attached to the beadbond layer; where the security laminate is larger than the plastic card; adhering the security laminate to the plastic card by the adhesive layer; and tearing the security laminate along an edge of the plastic card to form a tear in the security laminate that aligns with the edge of the plastic card.

In another embodiment, the invention is directed to a security card comprising: a plastic card having edges; and a tearable security laminate comprising: a retroreflective layer comprising a plurality of microbeads partially embedded in a beadbond layer, where the beadbond layer comprises polyurethane; a reflector layer between at least one of the microbeads and the beadbond layer; and an adhesive layer attached to the beadbond layer; where the security laminate is attached to the plastic card by the adhesive layer, where the adhesive layer comprises a polyester-based, hot-melt adhesive, and where the security laminate is tearable along an edge of the plastic card to form a tear in the security laminate that aligns with the edge of the plastic card.

As used herein, the term “normal lighting conditions” refers to the presence of ambient light that is substantially diffused, as with light typically used to light a room. The term “retroreflected light conditions” refers to ambient light that is substantially collimated, such as light cast by the headlight of an automobile or by a flashlight, and returns to the light source or the immediate vicinity thereof. The term “unaided eye” means normal (or corrected to normal) human vision not enhanced by, for example, magnification.

### BRIEF DESCRIPTION OF THE DRAWINGS

The present invention will be further explained with reference to the appended Figures, wherein like structure is referred to by like numerals throughout the several views, and wherein:

FIG. 1 illustrates a cross-sectional view of one embodiment of the security laminate of the present invention attached to a card;

FIG. 2 illustrates a top view of the security laminate of FIG. 1 attached to a card;

FIG. 3 illustrates a top view of tearing a security laminate of the Comparative Examples along the edge of a card;

FIG. 4 is a digitally recorded micrograph of the security laminate of Comparative Example 1 after it has been torn along the edge of a card;

FIG. 5 is a digitally recorded micrograph of the security laminate of Comparative Example 2 after it has been torn along the edge of a card;

FIG. 6 illustrates a top view of tearing one embodiment of the security laminate of the present invention along the edge of a card;

FIG. 7 is a digitally recorded micrograph of one embodiment of the security laminate of the present invention after it has been torn along the edge of a card; and

FIG. 7a is an enlarged view of a portion of the digitally recorded micrograph of the security laminate and card illustrated in FIG. 7.

### DETAILED DESCRIPTION OF THE INVENTION

Security laminates are often used to protect documents of value, such as identification cards, badges and driver licenses. Security laminates may also assist in providing identification, authentication, or to help protect against counterfeiting, alteration, duplication, and simulation. When prior art security laminates are applied to identification cards, badges, driver licenses or other types of cards, they are typically die cut to size and then laminated to the cards. For example, for a typical printed card body measuring 2.12 inches wide by 3.37 inches in length, a security laminate will be die cut to approximately 2 inches wide by 3.2 inches in length, and then laminated to the card by use of a hot roll laminator. However, this configuration leaves the peripheral area on the card body unprotected from weathering or tampering, and it is not preferable from a cosmetic point of view. It is possible to achieve edge to edge coverage with the use of prior art security laminates on cards, however it often becomes necessary to cut the security laminate before lamination to exactly match the dimensions of the card. For example, in this case, cutting the security laminated to precisely measure 2.12 inches wide by 3.37 inches in length to match the dimensions of the card. However, it is often difficult to have the edges of the cut security laminate exactly register or align with the edges of the card. In addition, such equipment is often expensive or difficult to use. Alternatively, other prior art security laminates may be used to achieve edge to edge coverage of the security laminate on the card by applying an oversized security laminate to the card and then to die cut the laminate around the card. However, it is often difficult to provide equipment for achieving such means and the equipment may actually end up cutting off portions of the card, if the alignment between the card and equipment is not exact.

Therefore, there exists a need to provide a security laminate that is capable of adhering to a card and is tearable along the edge of the card to provide a security laminate that can protect and cover the entire surface of the card (sometimes referred to as “edge to edge coverage”) and not leave peripheral areas of the card body unprotected. In addition, there is also a need for a security laminate that may be easily torn along the edge of the card by hand to form a “clean” tear. The term “clean tear”, as used herein, refers to the tear in the security laminate as conforming with or aligning with the edge of the card after the security laminate 10 has been torn against the edge 30 of the card 22, regardless of the shape or edges of the card. That is, when a person runs his finger along the edge of the card, the edge of the security laminate is adjacent or aligns with the edge of the card and it is smooth to the touch, in comparison to prior art security laminates that are torn by hand that leave jagged edges or security laminates that may lift off of the card surface after they are torn by hand.

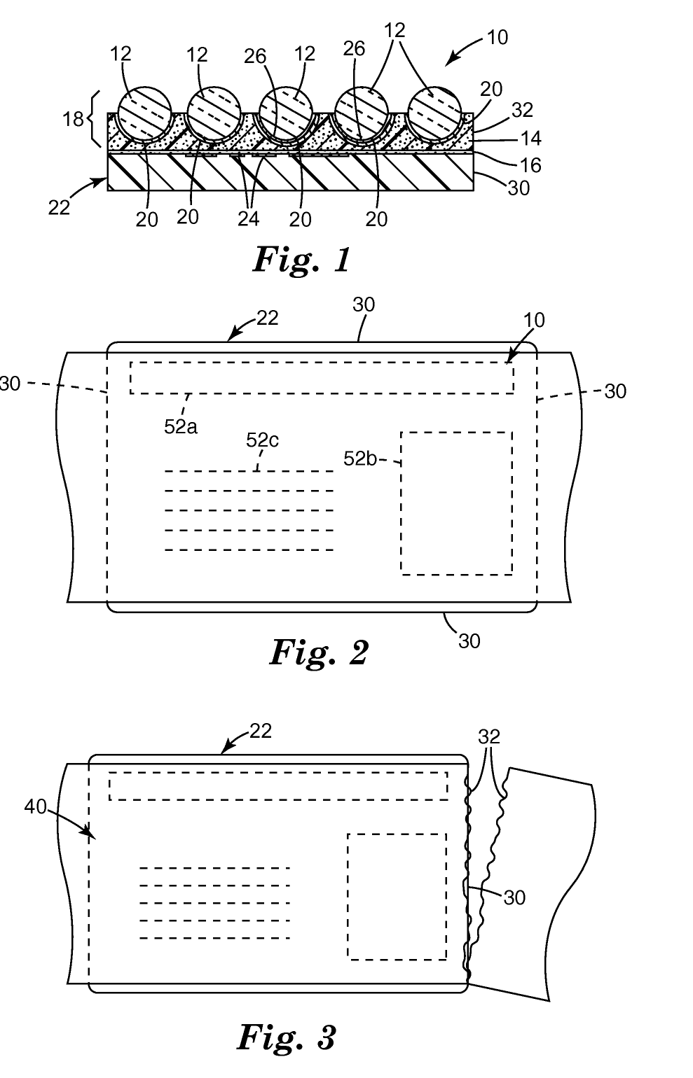

One embodiment of the tearable security laminate 10 of the present invention on a card is illustrated in FIG. 1. A security card is formed by combining a card with a security laminate. The security laminate 10 of the present invention includes a plurality of retroreflective glass microbeads 12, preferably with each having a reflector layer 20, partially embedded in and protruding from a beadbond layer 14. Together, the retroreflective microbeads 12, reflector layers 20 and beadbond 14 form a retroreflective layer 18. The microbeads 12 may be glass. In one embodiment, the microbeads 12 may range in size from about 10 micrometers (μm) to about 200 micrometers (μm) in diameter. In another embodiment, the microbeads range in size from about 40 micrometers to about 100 micrometers (μm) in diameter. Such glass microbeads 12 typically have a refractive index of at least about 1.8. Typically, the microbeads 12 of the retroreflective layer 18 are about hemispherically embedded into the beadbond layer 14. However, the amount of the microbeads 12 embedded into the beadbond layer 14 may preferably vary from about 25 to about 75% of the microbead diameter.

The reflector layer 20 is preferably a transparent, high refractive index material. Examples of useful reflector layer materials include bismuth trioxide, zinc sulfide, titanium dioxide, zirconium oxide, and a stack of zinc sulfide/Na₃AlF₆. One example of a suitable reflector layer 20 is a transparent, high refractive index material that is described in U.S. Pat. No. 3,801,183, which is hereby incorporated by reference.

One example of a suitable beadbond layer 14 is the inkjet receptive beadbond layer described in U.S. Pat. Publication No. 2006/0029753-A1, which is hereby incorporated by reference. This inkjet receptive beadbond layer 14 is used to accept images or other information in a discernable or readable form, typically by printing onto the exposed bead side of security laminate 10, with the majority of the printed ink retained in the inkjet receptive layer 14. The ink in the inkjet receptive beadbond layer 14 forms an image and other information, such as a picture or personalized information in the case of a passport or driver's license, illustrated in FIG. 2. The security laminate 10 may be imaged using water-based inks, solvent-based inks, and ultraviolet light curable inks. Preferably, the inkjet receptive beadbond layer 14 is water and abrasion resistant, and transparent.

In one preferred embodiment, the beadbond layer 14 includes polyurethane. In another preferred embodiment, the elongation at break of the beadbond layer is less than about 500%. In another preferred embodiment, the elongation at break of the beadbond layer is less than about 200%. Another example of a suitable beadbond layer 14 is disclosed in U.S. Pat. No. 4,530,859, which is hereby incorporated by reference. Other examples of suitable materials for the beadbond layer 14 is a polyurethane sold under the Bayhydrol brand available from Bayer Corporation in Pittsburg, Pa. These embodiments of the beadbond material for the beadbond layer 14 are especially useful for creating security laminates 10 that can be torn along the edge of the substrate or plastic card 22, because they are not as elastic and have a tendency to break more easily than other beadbond materials.

In one embodiment of the security laminate of the present invention, the security laminate 10 may include an overt indicia 24 that is preferably visible through the security laminate 10 when viewed under normal lighting conditions. In this embodiment, the retroreflective layer 18 is substantially transparent with overt indicia 24 being visible when illuminated under normal lighting conditions. The overt indicia 24 may include a printed image of a human face, signature, fingerprint, alphanumeric information, a barcode, or any combination thereof. The overt indicia 24 may be attached or printed directly to the beadbond layer 14 opposite the microbeads 12. (not shown) Alternatively, the overt indicia 24 may be attached or printed directly on the substrate 22, which is then attached to the security laminate 10 by a layer of adhesive 16. In this embodiment, the adhesive 16 is preferably transparent to allow the viewer to see the overt indicia 24. Alternatively, the overt indicia 24 may be observed in reverse format on the rear side of the security laminate 10.

In another embodiment, the security laminate 10 may include a floating image as an overt indicia 24. One example of a suitable floating image taught in U.S. Pat. No. 6,288,842 which is hereby incorporated by reference.

In another embodiment, the security laminate 10 may include a covert indicia 26 that is preferably visible when the security laminate 10 is illuminated by, for example, retroreflected light. The covert indicia 26 is located between the reflector layer 20 and the glass microbeads 12. The covert indicia 26 may be included adjacent a portion of the microbeads 12 or adjacent all of the microbeads 12. The different covert indicia 26 under adjacent microbeads 12 may form a printed image of symbol, word, logo, or any combination thereof.

The security laminate 10 may include any combination and any number of overt indicia 24, 28 and covert indicia 26. For example, the security laminate 10 may include an overt indicia 24 in combination with a covert indicia 26. As another example, the security laminate 10 may include either an overt indicia 24 or a covert indicia 26. As yet another example, the tamper-indicating security laminate 10 may include an overt indicia 28 in combination with a covert indicia 26. The security laminate 10 may just include an overt indicia 28, or may include an overt indicia 24, a covert indicia 26 and an overt indicia 28.

The security laminate 10 is preferably bonded to a substrate 22 by the adhesive 16, as illustrated in FIG. 1. However, the security laminate 10 may be otherwise attached to the substrate by other means known to those skilled in the art. The security laminate 10 can be used with any document of value such as passports, identification cards, labels, entry passes, ownership certificates, financial instruments, and the like. In one embodiment, the substrate 22 is a card, such as a plastic card 22, which is useful as an identification card or driver's license. The plastic for the card may be any plastic known to those skilled in the art. In one embodiment, the Young's modulus of the plastic card 22 is greater than about 1 GPa. This is to ensure that the plastic card is rigid enough to allow a user to tear the security laminate 10 along the edge 30 of the card 22. In another embodiment, the plastic card may be made from the polycarbonate or polyvinyl chloride or polyester materials or a combination thereof. Alternatively, the document of value may be composed of non-woven or woven materials. The security laminate 10 may be imaged to provide a printed image on the security laminate, and adhered to a document of value, such as a passport, or imaged, adhered to a backing, and then inserted into a document, as part of the manufacturing process. Alternatively, security laminate 10 may be first attached to or inserted into the document, and then imaged. The printed image in either embodiment may include a printed image of a human face, signature, fingerprint, alphanumeric information, a barcode, or any combination thereof.

Useful adhesives 16 for bonding the security laminate 10 to the substrate 22 include heat activated adhesives, ultraviolet light curable adhesives, thermosetting adhesives and remoistenable adhesives. In another embodiment, additional layers of adhesive or substrates may be attached to the substrate 22. For example, a layer of pressure sensitive adhesive and liner may be added to create a self-adhesive label. In a preferred embodiment, the adhesive 16 is a polyester-based, hot-melt adhesive. In another preferred embodiment, the thickness of the adhesive layer is less than about 3 mils. These embodiments of the adhesive 16 are especially useful for creating security laminates 10 that can be torn along the edge of the substrate or plastic card 22, as they provide sufficient adhesion between the security laminate 10 and the plastic card 22.

The adhesive 16 is illustrated in FIG. 1 has a single layer of adhesive. However, the adhesive layer 16 may be made from multiple layers of adhesive, or be formed from discrete portions of adhesive, such as an adhesive that is dot printed or the like.

FIG. 2 illustrates one embodiment of the security laminate 10 attached to a plastic card 22, such as an identification card, but prior to the user tearing the security laminate 10. In this illustrated embodiment, the security laminate extends beyond the left and right edges 30 of the card 22, but is narrower than the width between the top and bottom edges 30 of the card 22. However, this drawing is provided for illustrative purposes and for the convenience of seeing the edges 30 of the card 22. In one preferred embodiment, the security laminate 10 shall extend beyond all the edges 30 of the card, prior to tearing, to provide a security laminate 10 that can protect and cover the entire surface of the card 22 and not leave peripheral areas of the card body unprotected.

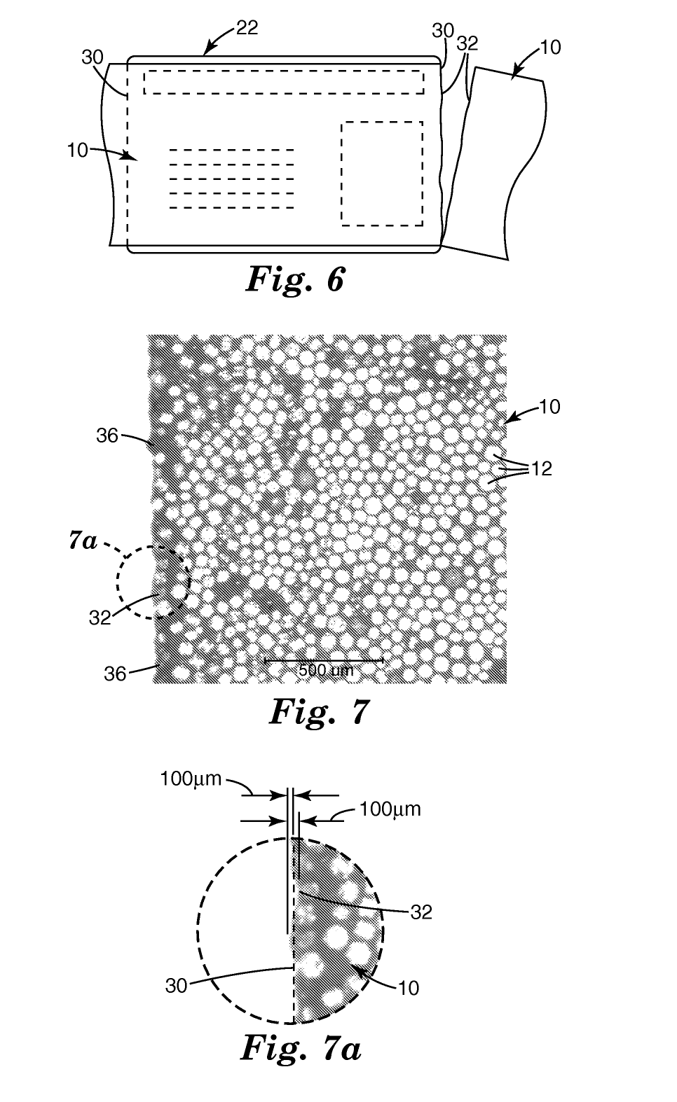

In FIG. 2, the identification card 22 includes overt indicia 52, which is printed on the surface of the card 22. Overt indicia 52a represents a bar code or other machine-readable zone. Overt indicia 52b represents a printed image of the human face of the owner of the identification card 22. Overt indicia 52c represents alphanumeric information about the holder of the identification card 22. The security laminate 10 may be used to protect the information printed on the identification card 22 and to prevent the information from being tampered with. FIG. 6 illustrates the security laminate 10 and card 22 of FIG. 2 after the security laminate 10 has been torn along the edge 30 of the card 22, which is explained in more detail below.

FIG. 3 represents the security laminates 40 of the Comparative Examples, which are explained in more detail below. In the Comparative Examples, it was observed that after tearing the security laminate 40 along the edge 30 of a card 22, the tear edge 32 of the security laminate was jagged or appeared in a zigzag path, or in some examples the security laminate actually lifted off the card itself. In other words, the tearing of the security laminate 40 did not result in smooth or clean edges, where the tear edge 32 closely aligned with the edge 30 of the card.

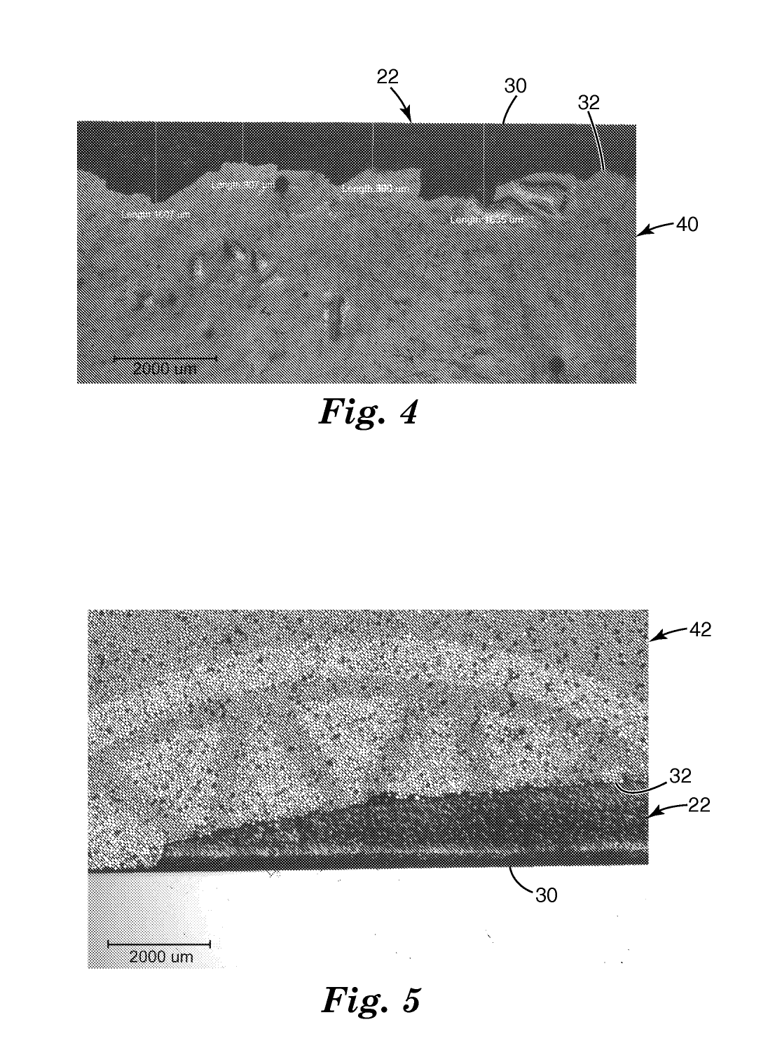

FIGS. 4 and 5 include micrographs of the comparative examples of the security laminate with a scale of 2000 μm. FIG. 4 illustrates a digitally recorded micrograph of the security laminate of Comparative Example 1 after it had been torn along the edge 30 of a card 22. As illustrated, the tear edge 32 has a jagged or zigzag appearance, and when a user runs their finger along the edge 32 it felt uneven or rough. This tear in the security laminate would not be understood to those skilled in the art as a “clean” tear or a tear with “clean” edges. In addition, FIG. 4 illustrates that the distance between the tear edge 32 of the security laminate and the edge 30 of the card 22 varies, and measures between 1635 μm and 807 μm.

FIG. 5 illustrates a digitally recorded micrograph of the security laminate of Comparative Example 2 after it has been torn along the edge 30 of a card 22. As illustrated, the tear edge 32 extends away from the edge 30 of the card 22, as the tear was made. As a result, the security laminate does not cover the entire area of the card allowing the peripheral area of the card 22 to be unprotected. In addition, the tear edge 32 is measured at some distance from the edge of the card 22, for instance in the range of 200 μm.

In contrast, FIG. 6 illustrates the tearing of the security laminate 10 of the present invention along the edge 30 of the card 22, where the tear of security laminate 10 closely aligns with the edge 30 of the card 22. The tearing of the security laminate 10 results in smooth or clean tear edges 32. In other words, the tear in the laminate is not jagged or in a zigzag pattern, and the laminate has not lifted off from the card, as illustrated in FIGS. 4 and 5. The card 22 may be in a shape other than a rectangle, and may instead take on various shapes. After the security laminate 10 is torn against the edges of the card 22, the tears in the laminate 10 conform with or align with the edges of the card, regardless of the shape of the card, or of any sharp or rounded corners of the card, or of any beveled edges of the card. In one embodiment, the tear is substantially a straight line when viewable by the eye. For example, the tear edge 32 is measured within 100 μm from the edge 30 of the card 22 from which the security laminate has been torn against. In another embodiment, the tear 32 propagates between adjacent microbeads 12, providing a relatively straight tear. This tear 32 follows along a tear propagation line or in a desired tear path between adjacent microbeads, specifically along the edge 30 of the card against which the security laminate 10 is pulled against. The tear propagation line is within a distance perpendicular from the desired tear path of less than twice the diameter of a microbead.

The tear strength of the security laminate 10 of the invention is reached before the bond strength of the adhesive 16 is surpassed to allow the security laminate to tear before lifting off from the card. In addition, the security laminate 10 of the invention allows tearing of the security laminate when attached to the card which aligns with the edge of the card.

FIG. 7 is a digitally recorded micrograph of the security laminate of one embodiment of the present invention after it has been torn along the edge 30 of a card 22. Specifically, FIG. 7 is a digitally recorded micrograph of the Working Example 1 described in more detail below. This micrograph has a scale of 500 μm., in comparison to the micrograph of FIGS. 4 and 5, which both had a scale of 2000 μm. The left hand side of the micrograph is where the security laminate 10 was torn against the edge of the card 22, which is not easily viewable in this figure, but is located directly below the tear edge 32. As shown, the tear edge 32 is a relatively straight line, especially in comparison to the tear edges 32 shown in FIGS. 4 and 5. The tear edge 32 propagates between the microbeads 12. The microbeads 12 help confine the tear path to a relatively straight line. Along the tear edge 32, there are some voids 36 where the microbeads 12 dislodged from the bead bond layer 14, as the tear was being made in the security laminate 10.

FIG. 7a illustrates an enlarged view of a portion of the digitally recorded micrograph of the security laminate and card illustrated in FIG. 7. The edge 30 of the card 22 is illustrated with a dotted line, and it aligns with the tear edge 32 of the security laminate 10. As illustrated, the tear edge 32 is measured within about 100 μm from the edge 30 of the card 22, which provides a relatively straight-line tear in the security laminate and provides a relatively smooth edge adjacent the edge 30 of the card 22.

The operation of the present invention will be further described with regard to the following detailed examples. These examples are offered to further illustrate the various specific and preferred embodiments and techniques. It should be understood, however, that many variations and modifications may be made while remaining within the scope of the present invention.

### Working Example 1

An adhesive solution was prepared by dissolving a polyester resin (Vitel 2200B, available from Bostik Findley, Middleton, Mass., or Adcote 2140, available from Rhom and Haas, Philadelphia, Pa.) by 40 wt % in methyl ethyl ketone (MEK) and toluene. The solution was then coated onto a silicone release liner (2 SAB, available from Mitsubishi Polyester Film, Greer, S.C.) using a coating speed of 10 foot/min. The coating was dried in a 3-zone oven with temperature set at 140° F., 150° F. and 160° F. The wet gap was varied so that the thickness of the dried adhesive was approximately 0.5 mil (12.7 μm), 1 mil (25.4 μm), 2 mil (50.8 μm) and 3 mil (76.2 μm).

A sheet was prepared according to the procedure described in Example 1 of U.S. Pat. No. 3,801,183, utilizing the beadbond disclosed in U.S. Pat. No. 4,530,859 both of which are hereby incorporated by reference. The face side of the sheet was then laminated onto the aforesaid adhesive using a roller heated at 190-195° C. Upon cooling, the carrier and release liner were peeled off and a security laminate of a retro-reflective film layer with the adhesive on one side was obtained. The retro-reflective film had two layers; a layer of glass micro beads with diameter of about 40-100 μm partially embedded in a beadbond layer of polyurethane.

The security laminate was then bonded onto a Tuff II card (Plastag Company, Elk Grove Village, Ill.) using a P-640i Zebra Printer (Zebra Technologies Corporation, Vernon Hills, Ill.). The card was a composite made of alternating layers of polyvinylchloride (PVC) and polyethylene terephthalate (PET), with the exposed sides of the cards used being PVC. The card measured approximately 85.5 mm long, 54 mm wide and 0.762 mm thick. The temperature of the upper and lower heat rollers in the printer was set at 145° C. The roller speed was set at about 0.5 inch/sec. Because the security laminate produced above was larger than the card, an overlay was obtained after lamination, i.e. the security laminate extended beyond the outer card dimensions. The overlaying portion of the security laminate was then removed by hand tearing along the edges of the card. Visual examination indicated that the torn edges of the security laminate were clean and smooth, except for those samples with 3-mil (76.2-μm) thick adhesive where slight roughness was observed. An optical micrograph of the plan view of a typical clean edge was taken using an optical microscope (SZX12 made by Olympus Corporation, Tokyo, Japan) attached to a digital CCD camera (Spot Insight made by Diagnostic Instruments, Sterling Heights, Mich.). The micrograph of FIG. 7 showed that the tear path for a typical clean edge had a tear path deviation within about 100 μm.

### Comparative Example 1

A 1-mil (25.4-μm) thick adhesive was prepared as in Working Example 1. A 0.92-mil (23.4-μm) thick neat PET film (3M Company, St. Paul, Minn.) was then laminated onto the adhesive using a Model 5560 bench laminator (Thermal Laminating Corporation, Evanston, Ill.). The temperature of the front and rear heating zones of the laminator was set at 138° C. and 157° C., respectively. After removing the release liner, the security laminate was bonded onto a Tuff II card using the P-Model 5560 bench lamination as described in Working Example 1. Upon hand tearing of the excessive portion of the security laminate against the edges of the card, the security laminate showed apparent fractures, giving rise to a zigzag tear path illustrated in FIG. 4, which varied up over 830 μm. This example appeared to suggest that in the security laminates of the present invention the use of glass microbeads is important to obtaining clean tear or smooth edges.

### Comparative Example 2

A 2-mil thick ethylene-acrylic acid (EAA) adhesive was extruded using Primacor 3330 resin (Dow Chemicals, Midland, Mich.). A security laminate with a retroreflective film layer with the EAA adhesive on one side was prepared as in Working Example 1. After removing the release liner, the security laminate was bonded onto a Tuff II card using a Model 5560 bench laminator as described in Comparative Example 1. There was a very weak adhesion between the security laminate and the card. As a result, when hand tearing the overlaying portion of the security laminate against the edges of the card, part of the security laminate peeled off from the card surface, resulting in the tear path illustrated in FIG. 5. This example appeared to suggest that in the security laminates of the present invention good adhesion between the laminate and the card is also important to obtaining clean or smooth tear edges.

### Comparative Example 3

A piece of 3M Scotchlite 9720 laminate (3M Company, St. Paul, Minn.) was bonded onto a Tuff TI card using a Model 5560 bench laminator as described in Comparative Example 1. Scotchlite 9720 has a similar construction to the retroreflective security laminate prepared in Working Example 1. But, the key component used in the beadbond formulation in Scotchlite 9720 was Vitel 3550 (Bostik Findley, Middleton, Mass.). It has an elongation at breack of over 2000%. Therefore, Scotchlite 9720 is very stretchy. This property of Scotchlite 9720 made it very difficult to hand tear the excessive security laminate away from the card. This example appeared to suggest that to obtain clean or smooth tear edges it is important not to use an elastic material as the beadbond.

The tests and test results described above are intended solely to be illustrative, rather than predictive, and variations in the testing procedure can be expected to yield different results.

The present invention has now been described with reference to several embodiments thereof. The foregoing detailed description and examples have been given for clarity of understanding only. No unnecessary limitations are to be understood therefrom. All patents and patent applications cited herein are hereby incorporated by reference. It will be apparent to those skilled in the art that many changes can be made in the embodiments described without departing from the scope of the invention. Thus, the scope of the present invention should not be limited to the exact details and structures described herein, but rather by the structures described by the language of the claims, and the equivalents of those structures.

What is claimed is:

1. A security card, comprising:
a plastic card having edges; and
a tearable security laminate comprising:
a retroreflective layer comprising a plurality of microbeads partially embedded in a beadbond layer;
a reflector layer between at least one of the microbeads and the beadbond layer; and
an adhesive layer attached to the beadbond layer;
wherein the security laminate is attached to the plastic card by the adhesive layer, and wherein the security laminate is tearable along an edge of the plastic card to form a tear in the security laminate that aligns with the edge of the plastic card.

2. The security card of claim 1, wherein the tear in the security laminate is a substantially straight line.

3. The security card of claim 1, wherein the tear edge is within about 100 μm from the edge of the plastic card.

4. The security card of claim 1, wherein the tear propagates between microbeads.

5. The security card of claim 1, wherein the microbeads comprise glass beads.

6. The security card of claim 1, wherein the diameter of the microbeads is about 40-100 μm.

7. The security card of claim 1, wherein the beadbond layer comprises polyurethane.

8. The security card of claim 1, wherein the elongation at break of the beadbond layer is less than about 500%.

9. The security card of claim 1, wherein the adhesive layer comprises a polyester-based, hot-melt adhesive.

10. The security card of claim 1, wherein the thickness of the adhesive layer is less than about 3 mils.

11. The security card of claim 1, wherein the Young's modulus of the plastic card is greater than about 1 GPa.

12. The security card of claim 11, wherein the plastic card comprises polycarbonate or polyvinyl chloride or polyester.

13. A method of making a security card, comprising the steps of:
providing a plastic card having edges;
providing a tearable security laminate comprising:
a retroreflective layer comprising a plurality of microbeads partially embedded in a beadbond layer;
a reflector layer between at least one of the microbeads and the beadbond layer; and
an adhesive layer attached to the beadbond layer;
wherein the security laminate is larger than the plastic card;
adhering the security laminate to the plastic card by the adhesive layer; and
tearing the security laminate along an edge of the plastic card to form a tear in the security laminate that aligns with the edge of the plastic card.

14. The method of claim 13, wherein the tear in the security laminate is a substantially straight line.

15. The method of claim 13, wherein the tear edge is within about 100 μm from the edge of the plastic card.

16. The method of claim 13, wherein the tear edge propagates between microbeads.

17. The method of claim 13, wherein the microbeads comprise glass beads.

18. The method of claim 13, wherein the diameter of the microbeads is about 40-100 μm.

19. The method of claim 13, wherein the beadbond layer comprises polyurethane.

20. The method of claim 13, wherein the elongation at break of the beadbond layer is less than about 500%.

21. The method of claim 13, wherein the adhesive layer comprises a polyester-based, hot-melt adhesive.

22. The method of claim 13, wherein the thickness of the adhesive layer is less than about 3 mils.

23. The method of claim 13, wherein the Young's modulus of the plastic card is greater than about 1 GPa.

24. The method of claim 13, wherein the plastic card comprises polycarbonate or polyvinyl chloride or polyester.

25. A security card, comprising:
a plastic card having edges; and
a tearable security laminate comprising:
a retroreflective layer comprising a plurality of microbeads partially embedded in a beadbond layer, wherein the beadbond layer comprises polyurethane;
a reflector layer between at least one of the microbeads and the beadbond layer; and
an adhesive layer attached to the beadbond layer;
wherein the security laminate is attached to the plastic card by the adhesive layer, wherein the adhesive layer comprises a polyester-based, hot-melt adhesive, and
wherein the security laminate is tearable along an edge of the plastic card to form a tear in the security laminate that aligns with the edge of the plastic card.
